(19) United States
(12) Patent Application Publication
(10) Pub. No.: US 2014/0117088 A1
(43) Pub. Date: May 1, 2014

(54) CASH REGISTERING APPARATUSING APPARATUS, POINT SERVER AND CASH REGISTRATION METHOD

(71) Applicant: TOSHIBA TEC KABUSHIKI KAISHA, Tokyo (JP)

(72) Inventor: Makiko Terabayashi, Shizuoka-ken (JP)

(73) Assignee: TOSHIBA TEC KABUSHIKI KAISHA, Tokyo (JP)

(21) Appl. No.: 14/065,507

(22) Filed: Oct. 29, 2013

(30) Foreign Application Priority Data
Oct. 31, 2012 (JP) 2012-240703

(51) Int. Cl. G06Q 20/20

(52) U.S. Cl. CPC G06Q 20/20
USPC 235/380

(57) ABSTRACT

In accordance with an embodiment, a cash registering apparatus comprises an input/output apparatus configured to input or output information; a communication interface configured to carry out communication with an external apparatus; a first reading section configured to read a first ID from a storage medium in which the first ID is stored and output a second ID which is fixedly assigned to the first ID based on the first ID; and a control section configured to receive accumulated points corresponding to the second ID from a point server in which accumulated points are stored for each second ID and carry out a checkout processing based on the accumulated points.

### CROSS-REFERENCE TO RELATED APPLICATION

This application is based upon and claims the benefit of priority from Japanese Patent Application No. 2012-240703, filed Oct. 31, 2012, the entire contents of which are incorporated herein by reference.

### FIELD

Embodiments described herein relate to a cash registering apparatus, a point server and a cash registration method.

### BACKGROUND

IC cards have been widely popularized in recent years to pay traffic fare, such as the train fare, and to settle a payment in a store.

On the other hand, a member card is distributed to a member in the company, and a service of granting points for each ID recorded in a member card is also established. A member can settle a checkout with the accumulated points based on a given ratio.

Such a payment settlement is carried out using a cash registering apparatus such as the so-called POS (Point Of Sales) register. The cash registering apparatus registers commodities for sale, unit price and quantities of commodities in a storage apparatus, calculates a total amount, inquires of a point server for storing accumulated points for each ID about accumulated points, and enables the point server to subtract the points used in a settlement from the accumulated points. Therefore, points can be used as cash.

However, as such a member card is issued by each company or even by each store, it is troublesome for a consumer having a variety of kinds of cards to manage the cards. Further, for a company or store issuing a member card, issuing a member card costs both money and manpower.

### BRIEF DESCRIPTION OF THE DRAWINGS

FIG. 1 is an external perspective view illustrating a cash registering apparatus;

FIG. 2 is a block diagram illustrating constitutions of a cash registering apparatus and a point server;

FIG. 3 is a diagram illustrating data constitution of a price database;

FIG. 4 is a diagram illustrating data constitution of a transaction file;

FIG. 5 is a diagram illustrating data constitution of a customer database;

FIG. 6 is flowchart illustrating a point-based settlement operation of a cash registering apparatus; and

FIG. 7 is flowchart illustrating a point-based accumulated point inquiry operation of a cash registering apparatus.

### DETAILED DESCRIPTION

In accordance with an embodiment, there is provided a cash registering apparatus comprising an input/output apparatus configured to input or output information; a communication interface configured to carry out communication with an external apparatus; a first reading section configured to read a first ID from a storage medium for storing the first ID and output a second ID which is fixedly assigned to the first ID based on the first ID; and a control section configured to receive accumulated points corresponding to the second ID from a point server in which accumulated points are stored for each second ID and carry out a checkout processing based on the accumulated points.

Embodiments of the cash registering apparatus, the point server and a cash registration program are described below in detail with reference to accompanying drawings.

In accordance with an embodiment, a cash registering apparatus comprises an input/output apparatus configured to input or output information; a communication interface configured to carry out communication with an external apparatus; a first reading section configured to read a first ID from a storage medium in which the first ID is stored and output a second ID which is fixedly assigned to the first ID based on the first ID; and a control section configured to receive accumulated points corresponding to the second ID from a point server in which accumulated points are stored for each second ID and carry out a checkout processing based on the accumulated points.

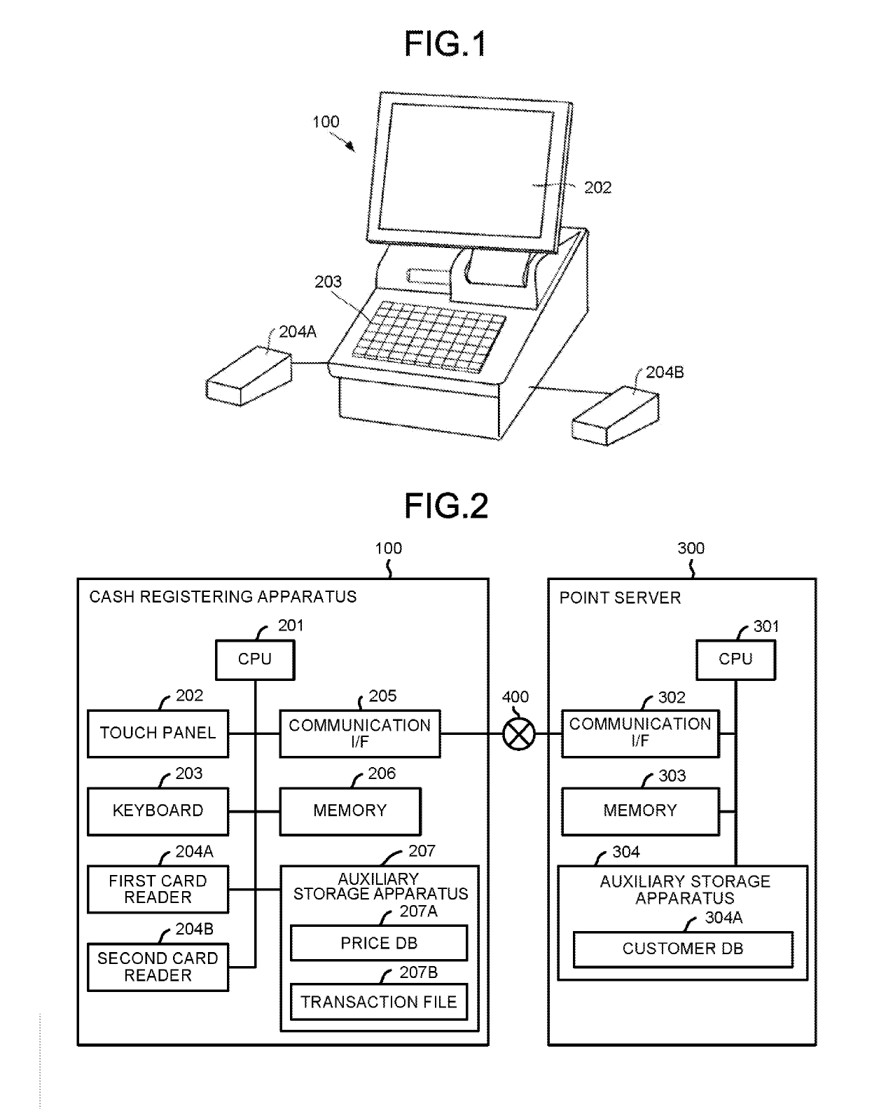

FIG. 1 is an external perspective view illustrating a cash registering apparatus 100. As shown in FIG. 1, the cash registering apparatus 100 comprises a touch panel 202 serving as an input/output apparatus; a keyboard 203 serving as an input apparatus; a first card reader 204A serving as a first reading section; and a second card reader 204B serving as a second reading section.

The first card reader 204A reads a first ID from a card serving as a storage medium and generates, based on the read first ID, a second ID which is fixedly assigned to the first ID. The second card reader 204B reads the first ID from the card.

The storage medium, which may be, for example, an IC card for storing a wireless tag, may be in any form as long as the storage medium is capable of storing the first ID. Further, the storage medium may also be a traffic IC card for paying the train fare or the bus fare or a portable information terminal such as a mobile phone comprising a wireless tag or the so-called credit card.

The first ID may be stored in a memory of a wireless tag or recorded in a magnetic stripe.

Further, the cash registering apparatus 100 may connects auxiliary apparatuses such as a scanner for reading a barcode attached to a commodity, a drawer for storing cash or a printer for forming an image for the transacted content on a recording medium.

The cash registering apparatus 100 may be used in a stand-alone manner or used by being connected with a store controller which has the same constitution as that of the cash registering apparatus 100. The store controller sends the information relating to a commodity stored therein to the connected cash registering apparatus 100 every time the information is changed.

FIG. 2 is a block diagram illustrating constitutions of the cash registering apparatus 100 and a point server 300. As shown in FIG. 2, the cash registering apparatus 100 comprises a CPU (Central Processing Unit) 201 serving as a control section, a touch panel 202, a keyboard 203, a card reader 204, a communication interface (hereinafter referred to as I/F) 205 for communicating with an external device, a memory 206 such as a ROM (Read-Only Memory) or a RAM (Random-Access Memory) serving as a storage apparatus, an auxiliary storage apparatus 207 serving as a nonvolatile storage apparatus such as a hard disk or even a flash ROM, a first card reader 204A, and a second card reader 204B.

The point server 300 comprises a CPU 301 serving as a control section of the point server, a communication I/F 302, a memory 303 and an auxiliary storage apparatus 304 serving as a nonvolatile storage apparatus such as a hard disk or even a flash ROM;

The cash registering apparatus 100 and the point server 300 are connected via the communication I/F 205, a communication network 400 and the communication I/F 302.

The auxiliary storage apparatus 207 stores a price database (database is hereinafter referred to as DB) 207A for storing unit price for each commodity and a transaction file 207B for storing the content of a transaction.

The auxiliary storage apparatus 304 stores a customer DB 304A for storing a second ID and accumulated points for each second ID.

In the present embedment, the point server 300 is arranged independent from a settlement server such as a server for the settlement of, for example, traffic fare. A user decides whether or not to pay with points before a settlement. An operator inputs an instruction to use points for settlement to the cash registering apparatus 100 if it is selected to settle with points.

If an instruction to use points for settlement is input, the cash registering apparatus 100 reads a first ID from a card using the first card reader 204A.

Based on the read first ID, the first card reader 204A generates and outputs a second ID which is fixedly assigned to the first ID.

For example, a code called as IDi containing an alphabet is stored in a traffic IC card as the first ID. The first card reader 204A converts the IDi into a second ID including integers and outputs the second ID.

The cash registering apparatus 100 inquires of the point server 300 about accumulated points based on the second ID.

The point server 300 retrieves the customer DB 304A based on the second ID to read accumulated points and sends the accumulated points to the cash registering apparatus 100.

The cash registering apparatus 100 settles a payment based on the points and instructs the point server 300 to subtract the points corresponding to the payment amount from the accumulated points.

Further, the second card reader is used when it is selected to settle based on the first ID. For example, the second card reader is used when settles a payment with the charged amounts in the traffic IC card.

A cash registration program is stored in the auxiliary storage apparatus 207. The control section 201 reads the cash registration program from the auxiliary storage apparatus 207 and stores in the memory 206, and reads a command from the memory 206 in sequence and executes the read commands.

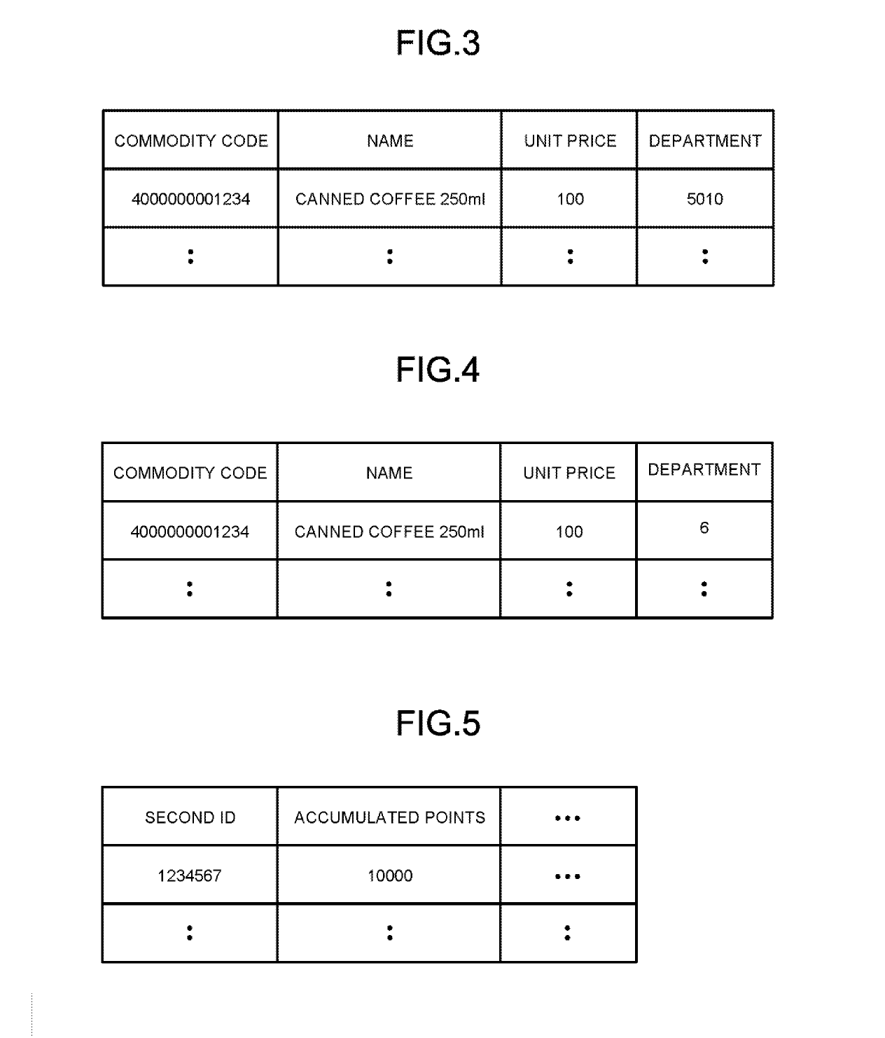

FIG. 3 is a diagram illustrating data constitution of the price DB 207A. As shown in FIG. 3, the price DB 207A stores, for each commodity, a commodity code fixedly assigned to a commodity, a name representing the name of the commodity, a unit price representing the specified price of the commodity, and a department representing a sales department.

In the data examples, the commodity code is ‘4000000001234’, the name is ‘canned coffee 250 ml’, the unit price is ‘100’, and the department is ‘5010’.

FIG. 4 is a diagram illustrating data constitution of the transaction file 207B. As shown in FIG. 4, the transaction file 207B stores, for each transaction, a commodity code, a name, a unit price and a quantity representing a sales quantity.

In the data examples, the commodity code is ‘4000000001234’, the name is ‘canned coffee 250 ml’, the unit price is ‘100’, and the quantity is ‘6’.

FIG. 5 is a diagram illustrating the data constitution of the customer DB 304A. As shown in FIG. 5, the customer DB 304A stores, based on the first ID recorded in a card, a second ID fixedly assigned to the first ID and accumulated points of each second ID. Further, the stored data is not limited to these.

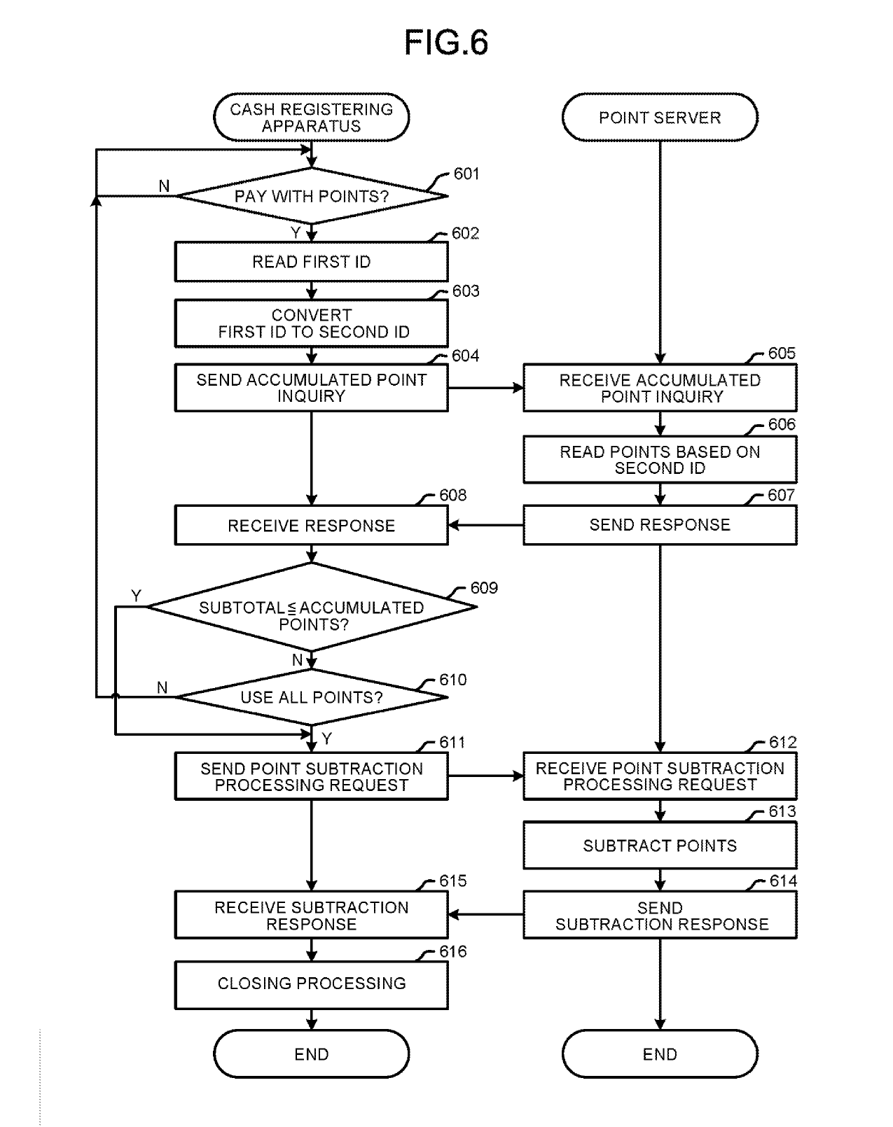

FIG. 6 is flowchart illustrating a point-based settlement operation of the cash registering apparatus 100. As shown in FIG. 6, in ACT 601, the cash registering apparatus 100 determines whether or not an instruction of a point-based payment is input. If the cash registering apparatus 100 determines that an instruction of a point-based payment is input, the flow proceeds to ACT 602, and if the cash registering apparatus 100 determines that an instruction of a point-based payment is not input, the flow returns to ACT 601.

In ACT 602, the cash registering apparatus 100 reads a first ID from a card with the first card reader 204A.

In ACT 603, the cash registering apparatus 100 converts, using the first card reader 204A, the first ID to a second ID which is fixedly assigned based on the first ID.

In ACT 604, the cash registering apparatus 100 sends an accumulated point inquiry and the second ID to the point server 300 together.

In ACT 605, the point server 300 receives the second ID and the accumulated point inquiry request.

In ACT 606, the point server 300 retrieves the customer DB 304A based on the received second ID and reads accumulated points of the second ID.

In ACT 607, the point server 300 sends the second ID and the accumulated points to the cash registering apparatus 100 as a response.

In ACT 608, the cash registering apparatus 100 receives the response from the point server 300.

In ACT 609, the cash registering apparatus 100 determines whether or not the payment subtotal is below the accumulated points. If the cash registering apparatus 100 determines that the subtotal is below the accumulated points, the flow proceeds to ACT 611, and if the cash registering apparatus 100 determines that the subtotal is not below the accumulated points, the flow proceeds to ACT 610.

In ACT 610, the cash registering apparatus 100 determines whether or not there is an input indicating using all points. If the cash registering apparatus 100 determines that there is an input indicating using all points, the flow proceeds to ACT 611, and if the cash registering apparatus 100 determines that there is no input indicating using all points, the flow returns to ACT 610.

In ACT 611, the cash registering apparatus 100 calculates the points to be subtracted from the accumulated points and sends the subtraction points and a point subtraction processing request to the point server 300.

In ACT 612, the point server 300 receives the subtraction points and the point subtraction processing request.

In ACT 613, the point server 300 subtracts the subtraction points from the accumulated points and stores the accumulated points after subtraction processing in the customer DB 304A as new accumulated points.

In ACT 614, the point server sends the second ID and the accumulated points after subtraction processing to the cash registering apparatus 100 as a subtraction response.

In ACT 615, the cash registering apparatus 100 receives the subtraction response.

In ACT 616, the cash registering apparatus 100 carries out checkout closing processing.

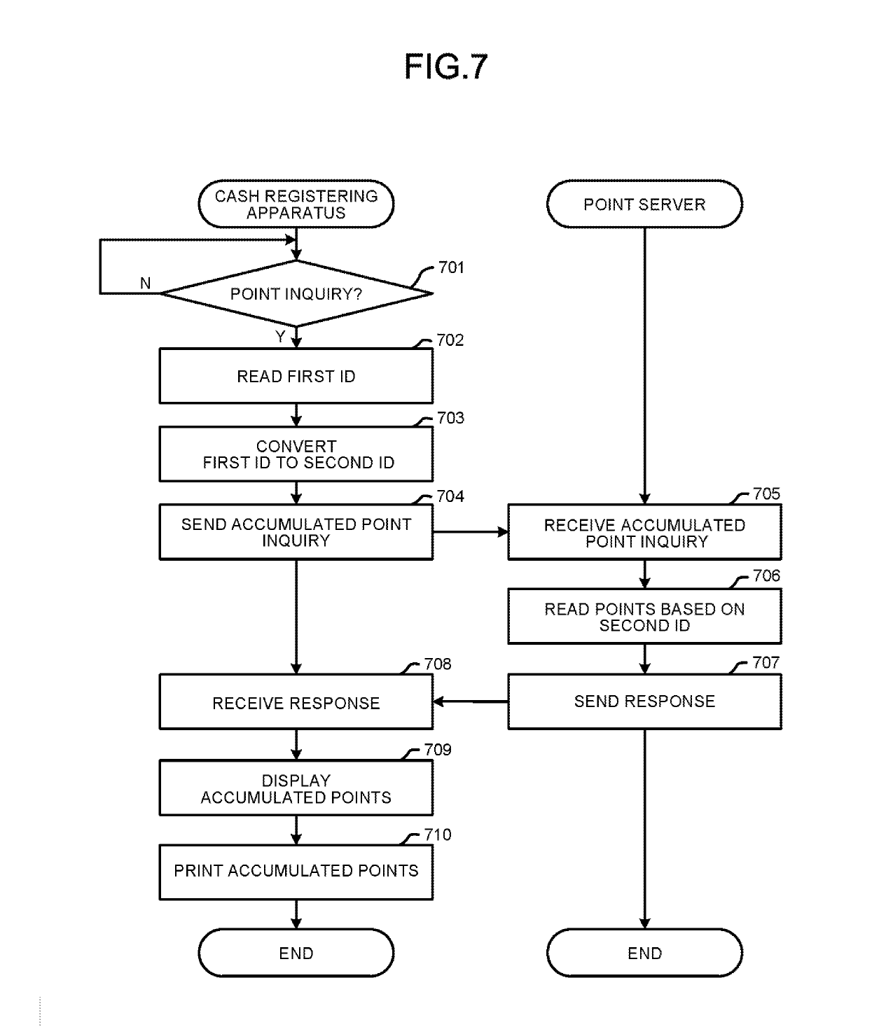

FIG. 7 is flowchart illustrating a point-based accumulated point inquiry operation of the cash registering apparatus 100. As shown in FIG. 7, in ACT 701, the cash registering apparatus 100 determines whether or not an accumulated point inquiry instruction is input. If the cash registering apparatus 100 determines that an accumulated point inquiry instruction is input, the flow proceeds to ACT 702, and if the cash registering apparatus 100 determines that an accumulated point inquiry instruction is not input, the flow returns to ACT 701.

In ACT 702, the cash registering apparatus 100 reads a first ID from a card with the first card reader 204A.

In ACT 703, the cash registering apparatus 100 converts, using the first card reader 204A, the first ID to a second ID which is fixedly assigned based on the first ID.

In ACT 704, the cash registering apparatus 100 sends an accumulated point inquiry and the second ID to the point server 300 together.

In ACT 705, the point server 300 receives the second ID and the accumulated point inquiry request.

In ACT 706, the point server 300 retrieves the customer DB 304A based on the received second ID and reads accumulated points of the second ID.

In ACT 707, the point server 300 sends the second ID and the accumulated points to the cash registering apparatus 100 as a response.

In ACT 708, the cash registering apparatus 100 receives the response from the point server 300.

In ACT 709, the cash registering apparatus 100 displays the accumulated points on the touch panel 202 serving as a display apparatus.

In ACT 710, the cash registering apparatus 100 prints the accumulated points using a printer.

As stated above, according to the present embodiment, a cash registering apparatus 100 comprises an input/output apparatus configured to input or output information; a communication interface 205 configured to carry out communication with an external apparatus; a first reading section configured to read a first ID from a storage medium in which the first ID is stored and output a second ID which is fixedly assigned to the first ID based on the first ID; and a control section configured to receive accumulated points corresponding to the second ID from a point server 300 in which accumulated points are stored for each second ID and carry out a checkout processing based on the accumulated points.

Thus, an effect that a point service can be used without issuing a new card is achieved.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A cash registering apparatus, comprising:
an input/output apparatus configured to input or output information;
a communication interface configured to carry out communication with an external apparatus;
a first reading section configured to read a first ID from a storage medium in which the first ID is stored and output a second ID which is fixedly assigned to the first ID based on the first ID; and
a control section configured to receive accumulated points corresponding to the second ID from a point server in which accumulated points are stored for each second ID and carry out a checkout processing based on the accumulated points.

2. The cash registering apparatus according to claim 1, further comprising:
a second reading section configured to read the first ID from the storage medium; wherein
if it is selected to settle with points from the input/output apparatus, the control section reads the first ID using the second reading section and converts the first ID to the second ID, receives accumulated points corresponding to the second ID from a point server in which the accumulated points are stored for each second ID, and carries out a checkout processing based on the accumulated points, and
if it is selected to settle based on the first ID but not the second ID from the input/output apparatus, the control section reads the first ID using the second reading section and carries out a checkout processing based on the first ID.

3. The cash registering apparatus according to claim 2, wherein the storage medium is capable of settling a traffic fare.

4. A point server, comprising:
a communication interface configured to carry out communication with an external apparatus; and
a control section configured to read accumulated points corresponding to a second ID from a customer database in which accumulated points are stored for each second ID and send the read accumulated points to a cash registering apparatus in a case where the second ID is received from the cash registering apparatus comprising a first reading section for reading a first ID from a storage medium in which the first ID is stored and outputting the second ID which is fixedly assigned to the first ID based on the first ID.

5. The point server according to claim 4, wherein
the storage medium is capable of settling a traffic fare.

6. A cash registration method, comprising:
reading a first ID from a storage medium in which the first ID is stored;
calculating a second ID which is fixedly assigned to the first ID based on the first ID;
receiving accumulated points corresponding to the second ID from a point server in which accumulated points are stored for each second ID; and
carrying out a checkout processing based on the accumulated points.
